(19) United States
(12) Patent Application Publication
(10) Pub. No.: US 2005/0115687 A1
(43) Pub. Date: Jun. 2, 2005

(54) Blind

(75) Inventor: Yuichi Miwa, Tokyo (JP)

Correspondence Address: SHLESINGER, ARKWRIGHT & GARVEY LLP, 1420 KING STREET, SUITE 600, ALEXANDRIA, VA, 22314, US

(73) Assignee: Yugenkaisha Misuzu, Tokyo (JP)

(21) Appl. No.: 10/497,545

(22) PCT Filed: Dec. 12, 2002
(86) PCT No.: PCT/JP02/13018

(30) Foreign Application Priority Data
Dec. 13, 2001 (JP) 2001-379719

(51) Int. Cl. E06B 3/06

(52) U.S. Cl. 160/236

(57) ABSTRACT

A blind so formed that at least one lateral side edge of a louver is pointed in a direction different from the direction of the middle part thereof in cross section, wherein the louver of soft cloth or soft resin is formed in a shape with pleats such that at least one lateral side edge thereof is pointed in the direction different from the direction of the middle part thereof in cross section, whereby, even if the louver is not formed or processed as such a hard louver as to always hold all the length thereof in such a shape pointed in a direction different from the direction of the middle part thereof in cross section, the blind having the louver with pleats can be manufactured at a low cost, and use, control, and transport configurations can be handled in the same manner as in a conventional normal band-shaped cloth louver and a soft resin louver.

### BACKGROUND OF THE INVENTION

The present invention relates to a blind, more particularly, to a blind for suspending a louver to each carrier of a runner group which runs along a rail, by a louver hook.

Conventionally, it is known that a louver is formed into an inverted sigmoid shape in a cross section (having inverted sigmoid folds or pleats), in order to make a blind have a spatial effect and a luxury. On forming the louver into the inverted sigmoid shape, at least one of side edges of the louver in a width direction is directed to a different direction with respect to an intermediate portion of the louver in a horizontal cross section (for example, Japanese Utility Model Publication JikoHei7-14623). In the above-mentioned blind, the louver is made of a hard material and is formed into the inverted sigmoid shape in the cross section. Furthermore, each of a louver hook and a balance weight is formed into an inverted sigmoid shape in a cross section. The louver hook is for use in suspending or hanging the louver with respect to the runner. The balance weight is attached to a lower end of the louver. More particularly, when each of the louver hooks 51 is formed into the inverted sigmoid shape and moves along a rail (not shown) by a tilt mechanism (not shown) as shown in FIG. 24, end portions of the louver hooks 51 which are adjacent to each other are overlapped in case where the blind is closed.

However, there is a problem in which a manufacturing price rate becomes expensive in the louver and the blind becomes expensive inasmuch as it is necessary to form each louver into the inverted sigmoid shape in the cross section by a hard adhesive even if the louver is made of a cloth, in the blind in which at least one of side edges of the louver in the width direction is directed to the different direction with respect to the intermediate portion of the louver in the horizontal cross section, in order to form the louver into the inverted sigmoid shape. In addition, the conventional louver has no flexibility such as a cloth louver or a soft plastic or resin louver inasmuch as the conventional louver is hard. When the louvers collide to each other, large sound generates. Furthermore, it is impossible to bend the louver in a longitudinal direction. In addition, an entire length of the louver becomes large inasmuch as the louver is formed into the inverted sigmoid shape in the cross section. As a result, there is a trouble in management and transport of the louvers. The cost for the management and transport becomes expensive.

### SUMMARY OF THE INVENTION

In order to dissolve the above-mentioned problems, it is an object of the present invention to provide a blind capable of shaping the louver into a shape with fold, even if the louver is made of a flexible material.

According to a first aspect of the present invention, there is provided a blind comprising a louver which is suspended by a louver hook to a carrier of a runner group which runs along a rail. The louver is made of a flexible material. The louver hook has a shape in which at least one of end portions in a width direction is directed to a different direction with respect to an intermediate portion thereof in a plane view. The flexible louver is stabilized into a shape with a fold in which at least one of side edges in the width direction is directed to a different direction with respect to an intermediate portion thereof in a horizontal section, by the louver hook. As a result, it is possible to form a shape with fold in which at least one of the side edges in the width direction is directed to the different direction with respect to the intermediate portion in the horizontal section in the flexible cloth louver or the soft plastic louver according to the blind of the present invention, even though the louver is not manufactured as a hard louver which has the shape in which at least one of the side edges in the width direction is always directed to the different direction with respect to the intermediate portion in the entire length. As a result, it is possible to cheaply manufacture the blind in which the louver has a fold. It is possible to deal with the louver of the present invention in a manner similar to a conventional usual strip shaped cloth louver or a conventional soft plastic louver in use, management, or transport fashion.

According to a second aspect of the present invention, the louver hook comprises a hook main body whose at least one of end portions in a width direction is directed to a different direction with respect to an intermediate portion thereof in a plane view and a louver clip having a shape similar to the hook main body. The louver clip is retractably attached to one end portion of the hook main body. An upper end portion of the louver made of the flexible material is sandwiched between the hook main body and the louver clip so that the louver has a shape with a fold in which at least one of side edges in the width direction is directed to a different direction with respect to an intermediate portion thereof in a horizontal section. As a result, it is unnecessary to shape the louver into the shape in which at least one of the side edges in the width direction is directed to the different direction with respect to the intermediate portion thereof in the horizontal section, in advance. It is possible to cheaply provide the blind having the louver in which at least one of the side edges in the width direction is directed to the different direction with respect to the intermediate portion thereof in the horizontal section. Furthermore, it is possible to dissolve a disadvantage in management and transport and it is possible to easily attach and detach the louver to the louver hook.

According to a third aspect of the present invention, both end portions in the width direction of said hook main body are bent so as to warp the both end portions to reverse directions with respect to half portions in the width direction and both end portions in the width direction of the louver clip are bent so as to warp the both end portions to reverse directions with respect to half portions. As a result, it is possible to smoothly make the louver hooks be contact with each other and to smoothly make the louver hooks be separated from each other in the warped portions of the both end portions of the louver hook. Furthermore, it is possible to make the blind reversely rotate and to smoothly open and close the blind, even if the louver has the shape in which at least one of the side edges in the width direction is directed to the different direction with respect to the intermediate portion in the horizontal section.

According to a fourth aspect of the present invention, the hook main body has a hook guide body and a guide roller which is positioned at an end portion of the hook main body. As a result, it is possible to fold the louver hooks with the adjacent louver hooks being closely contact with each other and to prevent the louver hooks from coming apart by the hook guide body, when closing the blind. In addition, it is possible to make the adjacent louver hooks smoothly move, inasmuch as the hook guide body of one louver hook is contact with the guide roller of another louver hook when each of the louver hooks rotate. Accordingly, it is possible to make the entire louver hooks smoothly move.

According to a fifth aspect of the present invention, the hook main body has a rotatable hooking portion which is hooked to the carrier. As a result, it is possible to make the louver hook rotate with respect to the carrier and each of the louver hooks can rotate within a predetermined range without louver hooks intertwining with each other. Accordingly, it is possible to make the louver smoothly move.

### BRIEF DESCRIPTION OF THE DRAWINGS

FIG. 1 shows a prospective view for illustrating a structure of a louver in a partial omission in a blind according to a first embodiment of the present invention;

FIG. 2 shows a prospective view for illustrating a louver hook in a condition of opening a louver clip with respect to a hook main body in the blind according to the first embodiment of the present invention;

FIG. 3 shows a prospective view for illustrating the louver hook in a condition of closing the louver clip with respect to the hook main body in the blind according to the first embodiment of the present invention;

FIG. 4 shows a plane view for illustrating the louver hook in a condition of closing the louver clip with respect to the hook main body in the blind according to the first embodiment of the present invention;

FIG. 5 shows a bottom view for illustrating the louver hook in a condition of closing the louver clip with respect to the hook main body in the blind according to the first embodiment of the present invention;

FIG. 6 shows a front view for illustrating only the louver in a partial omission in the blind according to the first embodiment of the present invention;

FIG. 7 shows a prospective view for illustrating a balance weight in a condition of opening the louver clip with respect to the hook main body in the blind according to the first embodiment of the present invention;

FIG. 8 shows a partial prospective view for illustrating a condition of suspending the louver to the louver hook in the blind according to the first embodiment of the present invention;

FIG. 9 shows a partial prospective view for illustrating a condition of supporting the balance weight to a lower end of the louver in the blind according to the first embodiment of the present invention;

FIG. 10 shows a front view in a partial omission for illustrating a condition of inserting a mandrel into scabbard shaped portion which is formed in upper and lower portions of the louver in a first variation according to the first embodiment of the present invention;

FIG. 11 shows a partial prospective view for illustrating a condition of using a bar shaped balance weight in a second variation according to the first embodiment of the present invention;

FIG. 12 shows a plane view for describing a movement of the louver hooks on opening and closing the louver in the present invention;

FIG. 13 shows a prospective view for illustrating a louver hook in a blind according to a second embodiment of the present invention;

FIG. 14 shows an enlarged sectional view along XIV-XIV line of FIG. 13 in the blind according to the second embodiment of the present invention;

FIG. 15 shows a plane view for illustrating a condition of closely contacting the louver hooks to each other on opening the blind in the second embodiment of the present invention;

FIG. 16 shows a sectional view along XVI-XVI line of FIG. 15 in the blind according to the second embodiment of the present invention;

FIG. 17 shows a prospective view for illustrating a hook main body in a blind according to a third embodiment of the present invention;

FIG. 18 shows an enlarged sectional view for illustrating a rotating mechanism of a hooking portion in the blind according to the third embodiment of the present invention;

FIG. 19(A) shows a schematically plane view for illustrating a louver hook having an inverted sigmoid shape in a cross sectional view;

FIG. 19(B) shows a schematically prospective view for illustrating a louver which is attached to the louver hook having the inverted sigmoid shape in the cross sectional view;

FIG. 19(C) shows a schematically prospective view for illustrating a condition of neighboring the louvers each of which is attached to the louver hook having the inverted sigmoid shape in the cross sectional view;

FIG. 20(A) shows a schematically plane view for illustrating a large louver hook of a central hatched portion;

FIG. 20(B) shows a schematically prospective view for illustrating a louver which is attached to the large louver hook of the central hatched portion;

FIG. 20(C) shows a schematically prospective view for illustrating a condition of neighboring the louvers each of which is attached to the large louver hook of the central hatched portion;

FIG. 21(A) shows a schematically plane view for illustrating a small louver hook of a central hatched portion;

FIG. 21(B) shows a schematically prospective view for illustrating a louver which is attached to the small louver hook of the central hatched portion;

FIG. 21(C) shows a schematically prospective view for illustrating a condition of neighboring the louvers each of which is attached to the small louver hook of the central hatched portion;

FIG. 22(A) shows a schematically plane view for illustrating a small crank shaped louver hook of a central hatched portion;

FIG. 22(B) shows a schematically prospective view for illustrating a louver which is attached to the small crank shaped louver hook of the central hatched portion;

FIG. 22(C) shows a schematically prospective view for illustrating a condition of neighboring the louvers each of which is attached to the small crank shaped louver hook of the central hatched portion;

FIG. 23(A) shows a schematically plane view for illustrating a large crank shaped louver hook of a central hatched portion;

FIG. 23(B) shows a schematically prospective view for illustrating a louver which is attached to the large crank shaped louver hook of the central hatched portion;

FIG. 23(C) shows a schematically prospective view for illustrating a condition of neighboring the louvers each of which is attached to the large crank shaped louver hook of the central hatched portion; and

FIG. 24 shows a plane view for describing movement of louver hooks in a conventional blind.

### PREFERRED EMBODIMENTS OF THE INVENTION

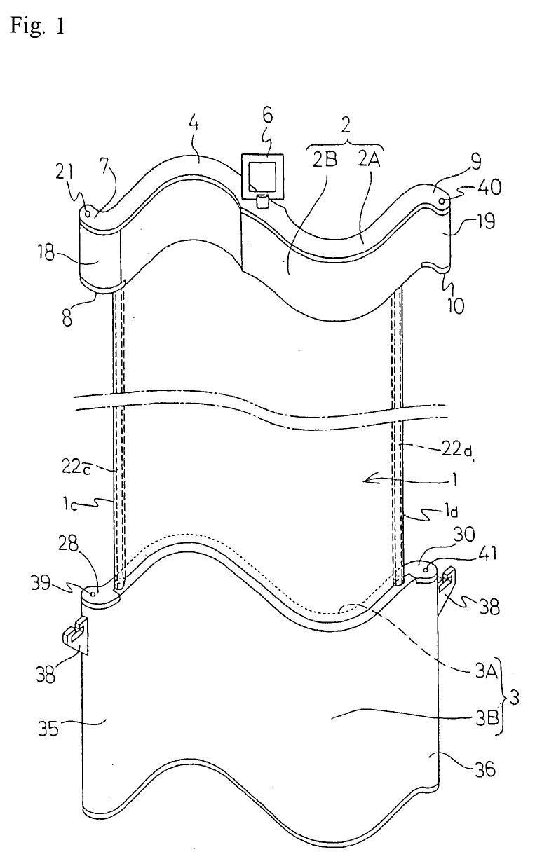

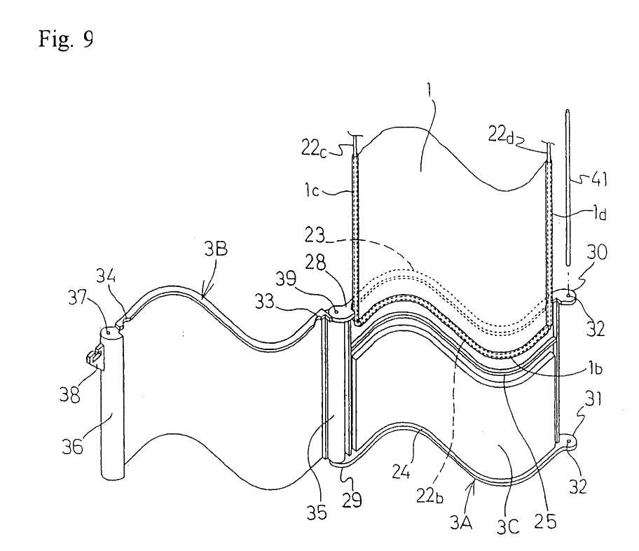

A detailed description will be made as regards a blind according to the present invention with reference to attached drawings. FIGS. 1 to 12 show views for illustrating a first embodiment of the present invention. FIG. 1 shows a view for illustrating one louver in a blind according to the present invention. Each of louvers 1 is made of a strip shaped flexible cloth such as a polyester. Although an individual louver 1 is equivalent of a flat strip shaped cloth, the individual louver 1 is subjected to a heating permanent press work based on a steam to be given a shape stabilization so that at least one of side edges of the louver in a width direction is directed to a different direction with respect to an intermediate portion of the louver in a horizontal cross section, when suspending the louver 1. For example, the individual louver 1 has an inverted sigmoid shape which is stabilized. Left and right weight codes 22c and 22d each of which has flexibility are inserted into left and right scabbard shaped portions 1c and 1d which are formed on left and right side edges of the louver 1, respectively.

The upper end portion of the louver 1 is supported or held together with the upper end portions of the left and the right weight codes 22c and 22d by a louver hook 2 having an inverted sigmoid shape in which at least one of end portions in a width direction is directed to a different direction with respect to the intermediate portion in a plane surface The louver 1 is suspended together with the left and the right weight codes 22c and 22d to a carrier of a runner that is not shown. By giving a weight of a balance weight 3 to the lower end of the louver 1, the louver 1 maintains a stable sigmoid shape having a fold in a cross section and having an orderly entire length, even if the louver 1 is made of a flexible cloth.

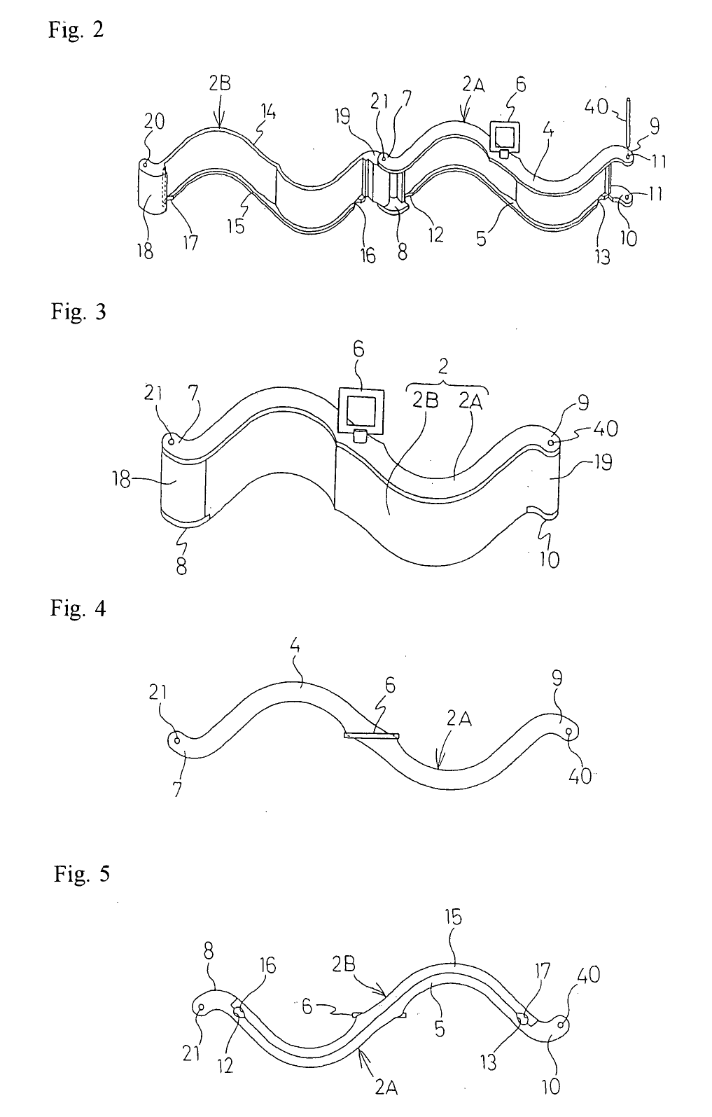

FIGS. 2 to 5 shows views for illustrating a structure of the louver hook 2. The louver hook 2 has a shape in which at least one of end portions is directed to a different direction with respect to an intermediate portion in a plane surface. The louver hook 2 comprises a hook main body 2A and a louver clip 2B. The hook main body 2A has an inverted sigmoid shape in which left and right half portions are bent to in the reverse directions, respectively. Similarly, the louver clip 2B has an inverted sigmoid shape. Each of the hook main body 2A and the louver clip 2B is made of a plastic material.

Ribs 4 and 5 are formed on the upper and the lower edges of the hook main body 2A. A square frame shaped hooking portion 6 is formed on a central part of the upper rib 4, in order to hook the carrier of the runner that is not shown. In addition, bifurcated and warped portions 7, 8, 9, and 10 are formed on left and right end portions of the hook main body 2A, respectively. The warped portions 7, 8, 9, and 10 integrally extend from the upper and the lower ribs 4 and 5 and are bent to a reverse directions with respect to the bent directions of the half portions of the hook main body 2A. Furthermore, Each of the warped portions 7, 8, 9, and 10 has a hole 11. The lower rib 5 has a width which is less than the width of the upper rib 4. The upper and the lower warped portions 7, 8, 9, and 10 are equal in a size to one another. Small concave portions 12 and 13 are formed on both end portions of lower rib 5.

Ribs 14 and 15 are formed on upper and lower edges of the louver clip 2B. Small concave portions 16 and 17 are formed on both end portions of lower rib 15. Left and right warped portions 18 and 19, which are not divided upwardly and downwardly, are formed on the left and the right ends of louver clip 2B. The left and the right warped portions 18 and 19 are bent to reverse direction with respect to the bend direction of the left and the right half portions of the louver clip 2B. Holes 20, which are penetrated upwardly and downwardly, are formed in the left and the right warped portions 18 and 19.

The warped portion 18, which is positioned at one end of the louver clip 2B, is located between the upper warped portion 7 and the lower warped portion 8 which are positioned at one end of hook main body 2A. By engaging an axis pin 21 into the hole 11 of the warped portion 7 and the hole 20 of the warped portion 8, the louver clip 2B is retractably attached to one end of the hook main body 2A.

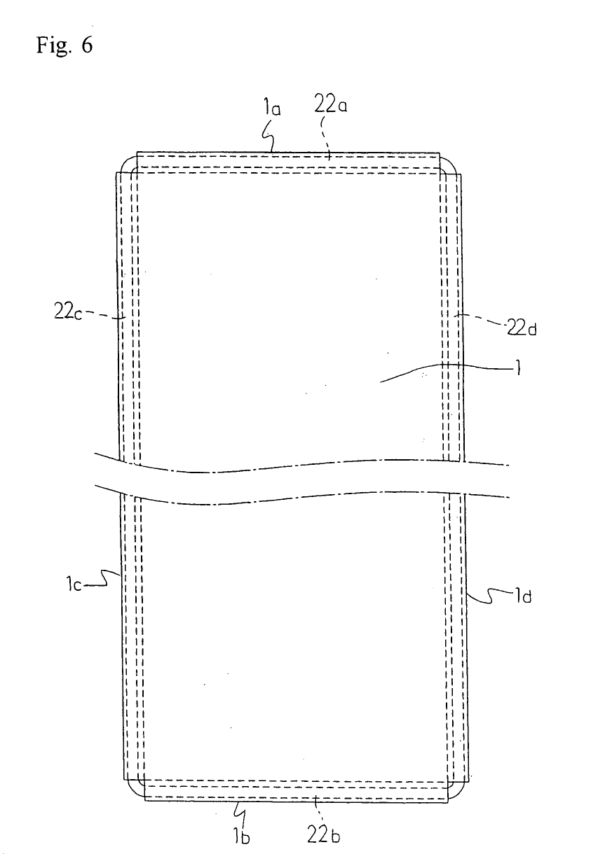

As shown in FIG. 6, Scabbard sections 1a, 1b, 1c and 1d are formed on four side edges which are positioned at the left, the right, the upper, and the lower edges of the louver 1. Weight codes 22a, 22b, 22c, and 22d are inserted into the scabbard sections 1a, 1b, 1c, and 1d, respectively. In the present embodiment, one continuous chain is used as weight codes 22a, 22b, 22c, and 22d.

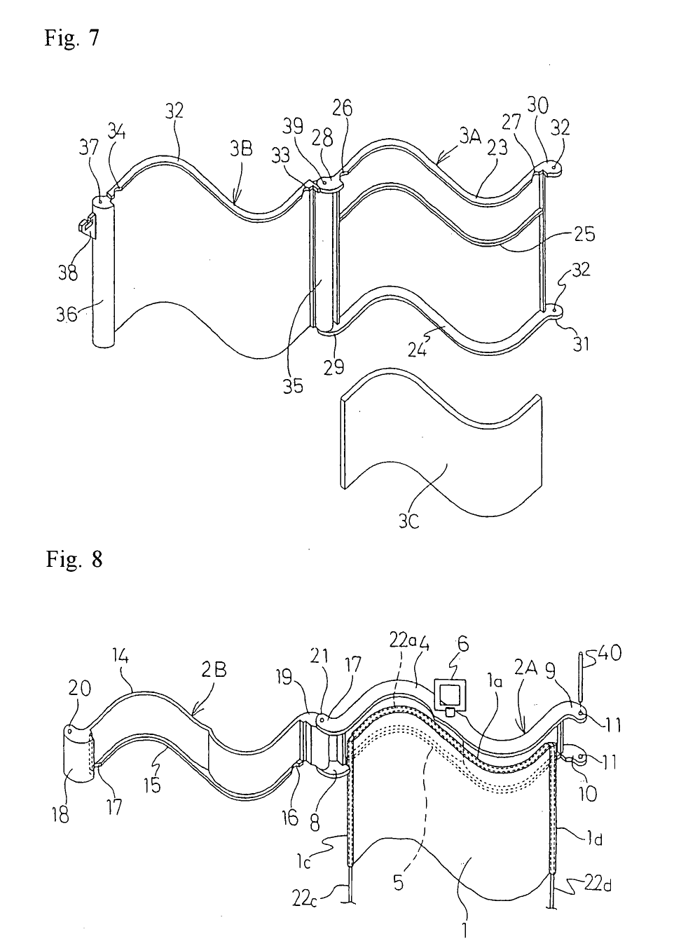

FIG. 7 shows a structure of the balance weight 3. The balance weight 3 has a width which is greater than the width of louver hook 2. The width extends upwardly and downwardly. The balance weight 3 is composed of a plate shaped weight main body 3A, a plate shaped louver clip 3B, and a weight 3C. The plate shaped weight main body 3A has an inverted sigmoid shape in which the left and the right portions are bent to reverse directions, respectively. Similarly, each of the plated shaped louver clip 3B and the weight 3C has an inverted sigmoid shape. Each of the weight main body 3A and the louver clip 3B is made of a plastic material. The weight 3C is made of a material such as a metal of a great specific gravity or a ceramic material.

Ribs 23, 24, and 25 are mounted on the upper and the lower side edges and a middle position near the upper side edge in the weight main body 3A. Small concave portions 26 and 27 are formed on both ends of the rib 23 which is positioned at the upper side edge of the weight main body 3A. Warped portions 28, 29, 30, and 31, which are bifurcated upwardly and downwardly are formed on the left and the right ends of weight main body 3A, respectively. The warped portions 28, 29, 30, and 31 integrally extend from the ribs 23 and 24 which are positioned at the upper and the lower side edges. The warped portions 28, 29, 30, and 31 are bent to a reverse direction with respect to the bend direction of the left and the right half portions of the weight main body 3A. Each of the warped portions 28, 29, 30, and 31 has a hole 32. The rib 23 of the upper side edge has a width which is less than the width of the rib 24 of the lower side edge. The upper and lower warped portions 28, 29, 30, and 31 have sizes which are equal to one another.

A rib 32 is formed on an upper side edge in the louver clip 3B of the balance weight 3. Small concave portions 33 and 34 are formed on both ends of the rib 32. Left and right warped portions 35 and 36, which are not divided upwardly and downwardly, are formed on the left and the right ends of the louver clip 3B. The warped portions 35 and 36 are bent to reverse directions with respect to the bend directions of the left and the right half portions of the louver clip 3B. In addition, holes 37, which are penetrated upwardly and downwardly, are formed in the left and the right warped portions 35. Chain hooking sections 38 for hooking a connecting chain (not shown) by the balance weights 3 are mounted on the left and the right warped portions 35.

The warped portion 35 of one end of the louver clip 3B is located between the upper warped portion 28 and the lower warped portion 29 of the one end of the weight main body 3A. By engaging an axis pin 39 into the holes 32 and 37, the louver clip 3B is retractably attached to one end of the weight main body 3A.

The louver 1, the louver hook 2, and the balance weight 3, which have the above-mentioned structures, are combined into a state shown in FIG. 1, as will be described hereinafter.

As shown in FIG. 8, The scabbard shaped portion 1a, which is positioned on the upper side edge of the louver 1 and into which the weight code 22a is inserted, is located between the upper rib 4 and the lower rib 5 of the hook main body 2A of the louver hook 2. The louver clip 2B is closed with respect to the hook main body 2A. The warped portion 19 of the louver clip 2B is positioned between the upper warped portion 9 and the lower warped portion 10 of the hook main body 2A. A stopping pin 40 is engaged into the correspondence holes 11 and 20 and the louver clip 2B is locked in a closed state with respect to the hook main body 2A.

As a result, the upper end section of the louver 1 is sandwiched between the lower rib 5 of the hook main body 2A and the lower rib 15 of the louver clip 2B with the inverted sigmoid shape. In addition, the left concave portions 12 and 16 and the right concave portions 13 and 17, which correspond to the ribs 5 and 15, are inserted into the left and the right side edge scabbard sections 1c and 1d and the weight codes 22c and 22d of the louver 1, as shown in FIG. 5. The upper side edge scabbard section 1a of the louver 1 is positioned at an upper position of the ribs 5 and 15 together with the weight code 22a. Accordingly, the louver 1 is suspended to the louver hook 2 without falling from the louver hook 2.

On the other hand, the lower side edge scabbard section 1b of the louver 1, into which the weight code 22b is inserted, is located between the upper side edge rib 23 and the middle rib 25 of the weight main body 3A of the balance weight 3. The weight 3C is located between the middle rib 25 and the lower side edge rib 24. The louver clip 3B is closed with respect to the weight main body 3A and the warped portion 36 of the louver clip 3B is positioned between the upper warped portion 30 and the lower warped portion 31 of the weight main body 3A. A stopping pin 41 is engaged into the correspondence holes 32 and 37 and the louver clip 3B is locked in a closed state with respect to the weight main body 3A.

As a result, the lower end section of the louver 1 is sandwiched between the upper rib 23 of the weight main body 3A and the rib 32 of the louver clip 3B with the inverted sigmoid shape. The left concave portions 26 and 33 and the right concave portions 27 and 34, which correspond to the ribs 23 and 32, are inserted into the left and the right side edge scabbard sections 1c and 1d and the weight codes 22c and 22d of the louver 1. The weight 3C is sandwiched between the weight main body 3A and the louver clip 3B to be stored. The lower side edge scabbard section 1b of the louver 1 is positioned at a lower position of the ribs 23 and 32 together with the weight code 22b. Accordingly, the balance weight 3 is held to the louver 1 without falling from the lower end section of the louver 1.

As described above, the upper end section of the louver 1 is held by the louver hook 2 with the inversed sigmoid shape and the lower end section of the louver 1 is held by the balance weight 3 with the inverted sigmoid shape. As a result, the louver 1 is transformed into the inverted sigmoid shape in the cross section in an entire shape. Inasmuch as the weight codes 22c and 22d are inserted into the left and the right scabbard sections 1c and 1d of the louver 1, the louver 1 is stably maintained into an orderly inverted sigmoid shape in the cross section in an entire length.

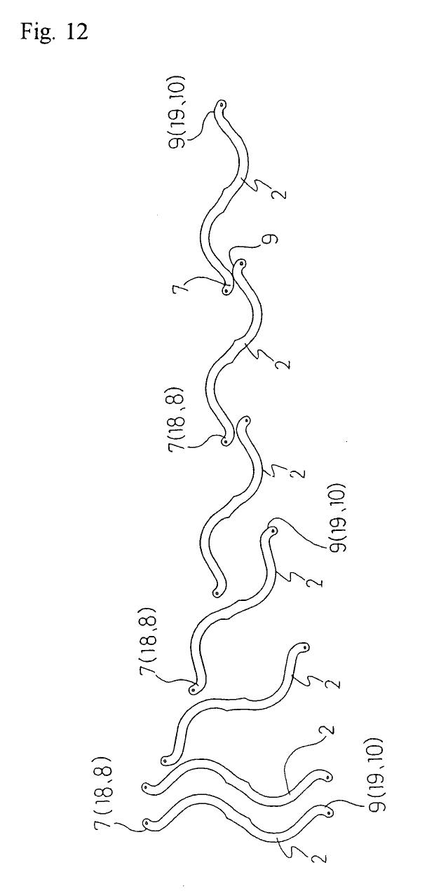

Although the bent left and the bent right half portions are partially overlapped in the louvers 1 when the blind is closed, it is possible to lower the resistance in case where the louvers 1 are contact with each other and are separated from each other, inasmuch as the rotations are guided in the louvers 1 by the left end warped portions 7, 8, and 18 and the right end warped portions 9, 10, and 19 in the louver hooks 2 and by the left end warped portions 28, 29, and 35 and the right end warped portions 30, 31, and 36 in the balance weights 3, in the overlapped state or when the louvers 1 separated from each other or when the louver 1 reversely rotates by the tilt mechanism which is not illustrated, as shown in FIG. 12. As a result, it is possible to smoothly carry out a reverse rotation and open and close although the blind has the louver 1 which is shaped into the inverted sigmoid shape in the cross section.

In addition, the outer surface of the central portion is shaped into a partial bent concave surface in each of the hook main body 2A and the louver clip 2B of the louver hook 2 as shown in FIGS. 1 to 5, in order to reduce the resistance in case where louvers 1 are contact with each other and are separated from each other.

In the first embodiment, the louver 1 is made of a flexible material and the louver hook 2 is shaped into a shape in which at least one of the end portions is directed to a different direction with respect to the intermediate portion in a width direction in a plane view. The scabbard sections 1c and 1d are formed on the both side edges of the louver 1 in the width direction. The weight codes 22c and 22d, each of which has flexibility, are inserted into the scabbard sections 1c and 1d. The flexible louver 1 is shaped into a shape in which at least one of the end portions is directed to the different direction with respect to the intermediate portion in the width direction in the horizontal section, by the left and the weight codes 22c and 22d. The shape of the louver 1 stabilized into the shape having the fold such as the inverted sigmoid shape in the cross section. As a result, The louver 1 is stably maintained into the orderly inverted sigmoid shape in the cross section in the entire length and the wrinkles occur in the louver 1, even if the louver 1 is made of a soft cloth. Incidentally, the left and the right weight codes 22c and 22d may be separated to each other. Alternatively, the left and the right weight codes 22c and 22d may be a continuous code. In other words, it is possible to make the flexible cloth louver or the soft plastic louver be shaped into a shape with fold which has the inverted sigmoid shape in the cross section, even if the louver is manufactured into a hard louver which is always shaped into the inverted sigmoid shape in the cross section in the entire length. It is possible to cheaply manufacture the blind having the louver with fold. Furthermore, it is possible to deal with the louver of the first embodiment in a manner similar to the conventional strip shaped cloth louver or the conventional soft plastic louver, in use, management and transport fashions.

In addition, the louver hook 2 is composed of the hook main body 2A and the louver clip 2B. The hook main body 2A is shaped in the inverted sigmoid shape in which the left and the right half portions are reversely bent to each other so that at least one of end portions is directed to the different direction with respect to the intermediate portion in the width direction in the plane view. The louver clip 2B is shaped into the inverted sigmoid shape and is retractably attached to the one end of the hook main body 2A. When the upper end portion of the flexible louver 1 is sandwiched between the hook main body 2A and the louver clip 2B, the louver 1 is shaped into a shape in which at least one of side edges is directed to the different direction with respect to the intermediate portion in the width direction in the horizontal section. The louver 1 is shaped into the inverted sigmoid shape with fold in the cross section. As a result, it is possible to make the flexible cloth louver or the soft plastic louver to certainly be shaped into the shape with fold. Furthermore, it is possible to cheaply provide the blind having the louver of the inverted sigmoid shape in the cross section, even though louver 1 is shaped into the inverted sigmoid shape in the cross section in advance. In addition, it is possible to dissolve the disadvantages in management and transport and it is possible to easily attach or detach the louver 1 to the louver hook 2.

The both end portions of the hook main body 2A and the both end portions of the louver clip 2B are bent to reverse direction with respect to the half portions in the width direction, respectively. The left and the right end portions of the hook main body 2A and the left and the right end portions of the louver clip 2B are bent to the reverse directions with the bend directions of the left and the right half portions, respectively. As a result, it is possible to reduce the resistance in case where the louver hooks 2 are contact with each other and are separated from each other, even if the louver 1 has the inverted sigmoid shape in the cross section. Therefore, it is possible to smoothly guide the louver hooks 2 in case where the louver hooks 2 are contact with each other and are separated from each other. It is possible to make the blind reversely rotate (reversely rotate by the tilt mechanism) and it is possible to smoothly open and close the blind.

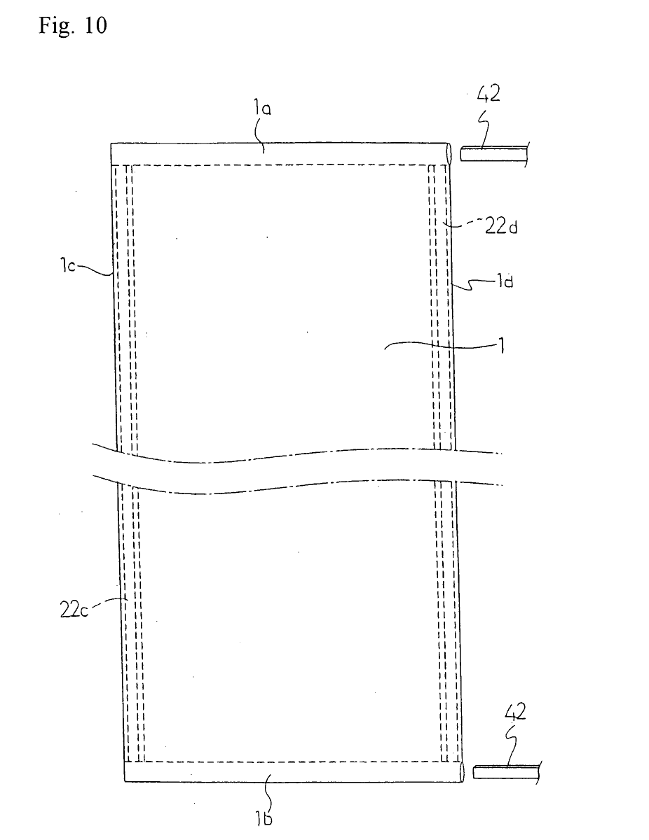

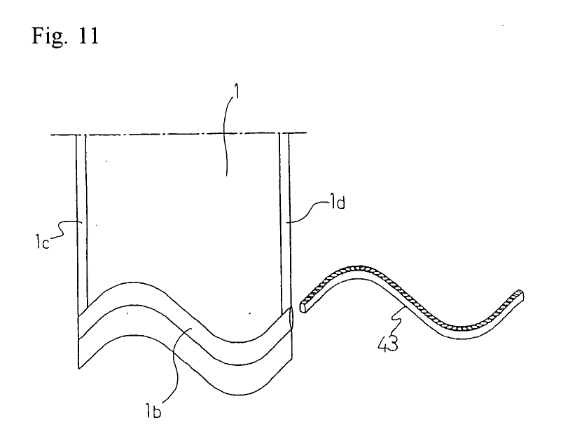

Incidentally, an elastic spindle 42 may be inserted into the upper and the lower side edge scabbard sections 1a and 1b as shown in FIG. 10, although the weight codes 22a and 22b are inserted into the upper and the lower side edge scabbard sections 1a and 1b of the louver 1 in the first embodiment, using the continuous chain as the weight codes 22a to 22d. As a result, it is possible to easily transform and restore the louver 1, even though the louver hooks 2 are different in shape from one another. In addition, a bar shaped balance weight 43 having the inverted sigmoid shape may be used as shown in FIG. 11 instead of the plate shaped balance weight 3. The bar shaped balance weight 43 may be inserted into the lower side edge scabbard section 1b. As a result, it is possible to simplify the structure of the lower side of the louver 1.

In addition, it is always not necessary to sandwich the upper end portion of the louver between the hook main body 2A and the louver clip 2B, inasmuch as it is possible to stably maintain the louver 1 to the orderly inverted sigmoid shape in the cross section by the left and the right weight codes 22c and 22d which are inserted into the left and the right side edge scabbard sections 1c and 1d in the first embodiment, in case where the louver 1 is manufactured into a stabilized shape in which the louver 1 is shaped into the inverted sigmoid shape on suspending. It is not always necessary to subject the balance weight in the manner similar to the above-mentioned manner. Furthermore, it is not always necessary to subject the louver 1 in the manner similar to the above-mentioned manner in case of using the flexible soft plastic strip shaped sheet as the louver instead of the cloth. The louver may have another shape as the shape with fold which is stabilized on hanging, instead of the inverted sigmoid shape. The louver 1 may have a plate shape before hanging. Each of the weight codes 22c and 22d is not defined to the chain. Another member, which extends vertically when the other member is suspended to the louver hook 2 and which has flexibility, may be used as each of the weight codes 22c and 22d.

For example, an elastic tool such as a coil spring may be mounted on an axis portion which is connected to the hook main body 2A of the hooking portion 6 in the first embodiment, although no illustration is made. The elastic tool is for use in making the louver 1 move downwardly when the louver 1 is pulled down, in order to prevent parts such as the carrier and louver hook 2 from damage.

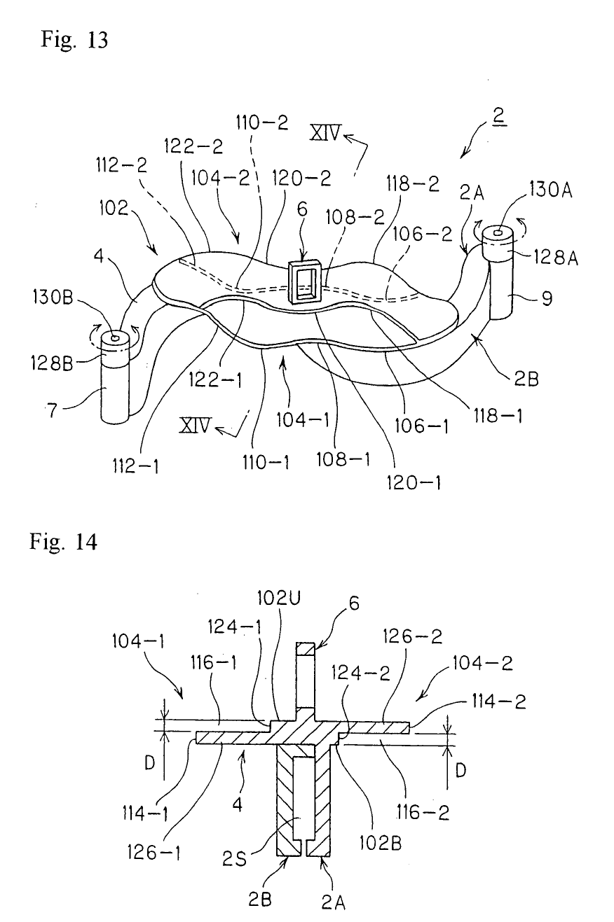

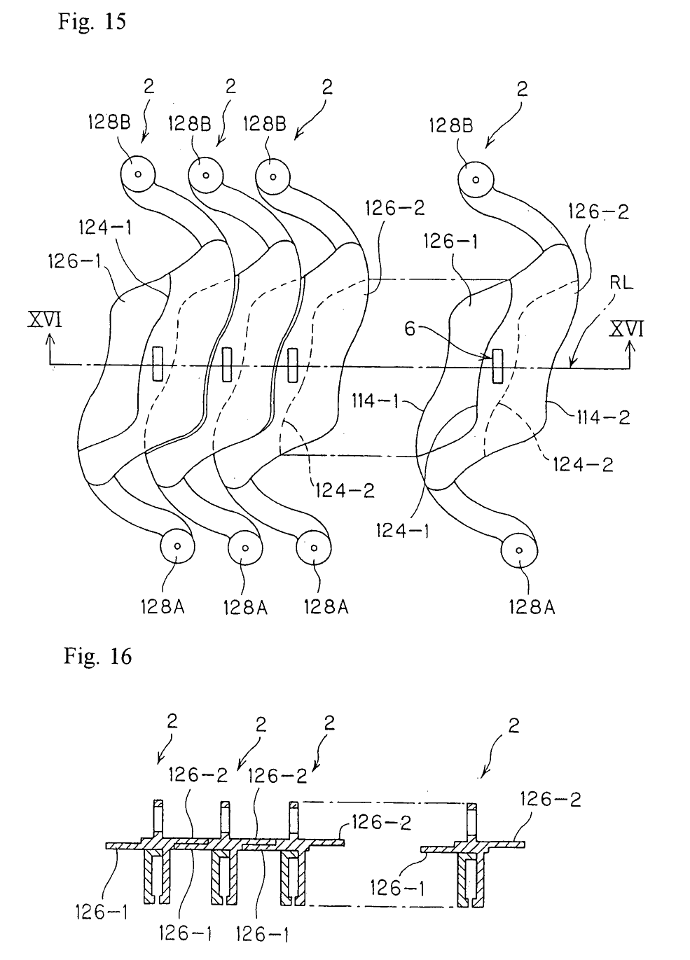

FIGS. 13 to 16 show a second embodiment of the present invention.

In the second embodiment, the similar parts will be designated in reference numerals similar to the first embodiment.

In second embodiment, a hook guide body 102 having a plate shape in horizontal direction is integrally mounted on the upper rib 4 of the hook main body 2A in the louver hook 2 which has a structure similar to the first embodiment. The hook guide body 102 is shaped into an approximate lozenge shape in a plane view and is directed to a direction perpendicular to a rail line RL. The hook guide body 102 is composed of symmetrical one side guide section 104-1 and another side guide section 104-2.

The one side guide section 104-1 is composed of one side wave shaped outer surface 114-1 in a plane view. The one side wave shaped outer surface 114-1 has one side first bent portion 106-1, one side central concave portion 108-1, and one side second inclined portion 112-1. The one side first bent portion 106-1 horizontally extends in one side of the hook main body 2A and is bent in one end portion of the hook main body 2A. The one side central concave portion 108-1 slightly sags in a central part. The one side second inclined portion 112-1 is slantingly directed in another end portion of the hook main body 2A through a one side projection portion 110-1 from the one side central concave portion 108-1. Furthermore, the one side guide section 104-1 is composed of one side wave shaped inner surface 124-1 in a plane view. The one side wave shaped inner surface 124-1 has one side first concave portion 118-1, one side central arc portion 120-1 positioned at a central part, and another side second concave portion 122-1 so as to form one side upper groove 116-1 having a depth D on the upper surface 102U. By the one side upper groove 116-1, one side stopping portion 126-1 is formed.

The other side guide section 104-2 is composed of another side wave shaped outer surface 114-2 having a wave shape similar to the one side wave shaped inner surface 124-1 in a plane view. The other side wave shaped outer surface 114-2 has another side first convex portion 118-2, another side central arc portion 120-2, and another side second convex portion 122-2. The other side first convex portion 118-2 horizontally extends in another side of the hook main body 2A and has a shape which corresponds to the one side first concave portion 118-1 in one end portion of the hook main body 2A. The other side central arc portion 102-2 has a shape which corresponds to the one side central arc portion 120-1 in a central portion of the hook main body 2A. The other side second convex portion 122-2 has a shape which corresponds to the one side second concave portion 122-1 in the other end portion of the hook main body 2A. Furthermore, the other side guide section 104-2 is composed of another side wave shaped inner surface 124-2 having a wave shape similar to the one side wave shaped outer surface 114-1 in a plane view. The other side wave shaped inner surface 124-2 has another side first bent portion 106-2, another side central projection portion 108-2, and another side inclined portion 112-2. In order to form another side lower groove 116-2 of a depth D on a lower surface 102B, the other side first bent portion 106-2 has a shape which corresponds to the one side first bent portion 106-1 in the one end portion. The other side central projection portion 108-2 has a shape which corresponds to the one side central concave portion 108-1 in the central part. From the other side central projection portion 108-2 through another side concave part 110-2 having a shape which corresponds to the one side projection part 110-1, the other side inclined portion 112-2 corresponds to the one side inclined portion 112-1 in the other end portion of the hook main body 2A. By the other side lower groove 116-2, another side stopping portion 126-2 is formed which has a shape similar to the one side stopping portion 126-1 and which is overlapped to the one side stopping portion 126-1.

In addition, the hooking portion 6 integrally stands at a central part of the hook guide body 102.

Furthermore, one end and another end guide rollers 128A and 128B are rotatably mounted on the upper surfaces of warped portions 7 and 9 which are positioned at both end portions of the hook main body 2A. The one end and the other end guide rollers 128A and 128B can be contact with round surfaces of the outer surfaces 120 of the hook guide body 102 another louver hook 2 adjacent to one louver hook. In addition, a sandwiching space 2S for the scabbard section 1a and the weight code 22a is formed between the hook main body 2A and the louver clip 2B.

According to the structure of the second embodiment, the other side stopping portion 126-2 of the other louver hook 2 corresponds to the one side upper groove 116-1 of the adjacent one louver hook 2 and stops to the one side upper groove 116-1, in case of opening the blind and jointing the louver hooks 2 to each other. Furthermore, the one side stopping portion 126-1 of the one louver hook 2 corresponds to the other side lower groove 116-2 of the other louver hook 2 and stops to the other side lower groove 116-2. As a result, it is possible to fold the louver hooks 2 with the louver hooks 2 being closely contact with each other. It is possible to prevent the louver hooks 2 from coming apart by swing and it is possible to arrange the entire louver hooks.

When closing the blind, the louver hooks 2, which are adjacent to each other, are subjected to rotation (reverse rotation). At that time, the guide rollers 128A and 128B, which are positioned at both ends of each louver hook 2, rotate and are contact with the one side wave shaped outer surface 114-1 and the other side wave shaped outer surface 114-2 of the adjacent louver hook 2. As a result, it is possible to make each louver hook 2 smoothly rotate. When each louver hook 2 moves along the rail line RL, it is possible to make the louver hooks 2 smoothly move one by one in accordance with the rotations of the guide rollers 128A and 128B which are positioned at both ends of each louver hook 2. Therefore, it is possible to smoothly close the blind without entanglement of the louver hooks 2.

When a user opens only each louver hook 2 after closing the blind, it is possible to make each louver hook 2 smoothly rotate inasmuch as the guide rollers 128A and 128B, which are positioned at both ends of each louver hook 2 rotate and are contact with the one side wave shaped outer surface 114-1 and the other side wave shaped outer surface 114-2 of the adjacent louver hook 2.

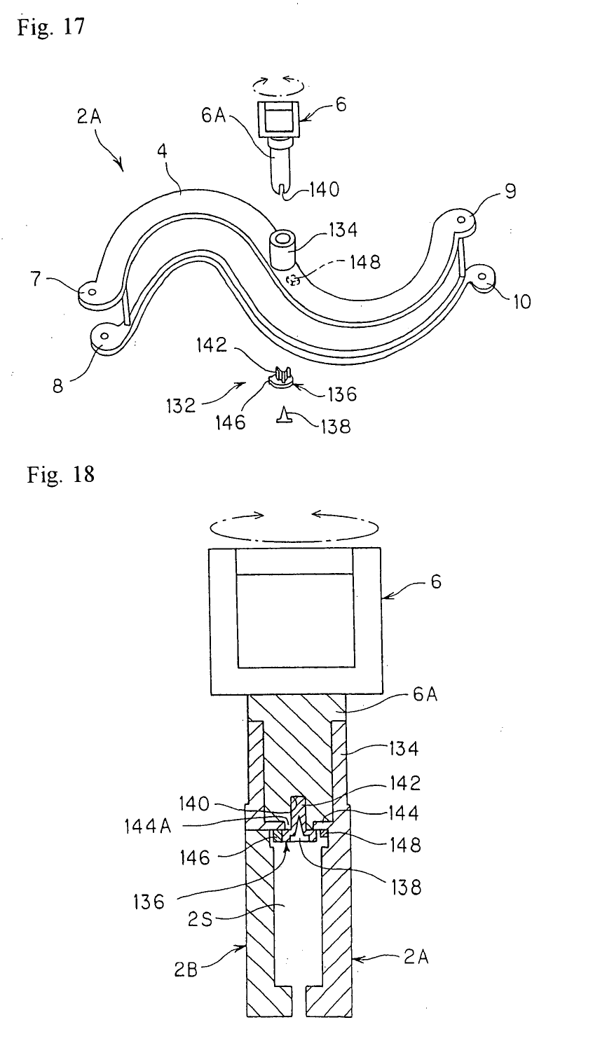

FIGS. 17 and 18 show a third embodiment of the present invention.

In the third embodiment, the hooking portion 6, which is hooked to the carrier, is rotatably mounted by a rotation mechanism 132 on the upper rib 4 of the hook main body 2A in the louver hook 2.

The rotation mechanism 132 has a cylindrical portion 134 which stands on the upper surface of the rib 4 of the hook main body 2A. The axis portion 6A of the hooking portion 6 is inserted into the cylindrical portion 134 from a upper side. A supporting member 135 and a supporting pin 138 in a lower side supports the axis portion 6A to the rib 4 and the hooking portion 6 is rotatably supported with respect to the rib 4.

In this case, three slits 140 are top end of the axis portion 6A of the hooking portion 6. Engaging pins 142 of the supporting member 136 and the supporting member 136 is stopped to a stop supporting portion 144 which forms a member inserting hole 144A of the rib 4. A supporting pin 138 is inserted into a central part of the supporting member 136 from a lower side, in order to support the axis portion 6A. In addition, a rotation restraining projection portion 146 is formed on a part of outer circumference part of the supporting member 136 and a rotation restraining portion 148 is formed on a lower surface of the rib 4 of the hook main body 2A. The rotation restraining portion 148 is contact with the rotation restraining projection portion 146.

Incidentally, description will be omitted with the louver clip 2B of the third embodiment, inasmuch as the louver clip 2B of the louver hook 2 in the third embodiment has a structure similar to the structure of the louver clip 2B of the first embodiment that is shown in FIG. 2. In addition, a sandwiching space 2S for the scabbard section 1a and the weight code 22a is formed between the hook main body 2A and the louver clip 2B as shown in FIG. 18.

According to the structure of the third embodiment, it is possible to make the adjacent louver hooks 2 rotate within a predetermined range, the louver hook 2 can rotate through the hooking portion 6 which rotates with respect to the carrier. As a result, it is possible to smoothly move the louver 1 without entanglement of the louver hooks 2, when the louver hooks 2 are contact with each other or the louver hooks 2 are separated from each other.

Incidentally, it is possible to practice variations as followings in the present invention without defining the shape of the louver hook described in each of the above-mentioned embodiments.

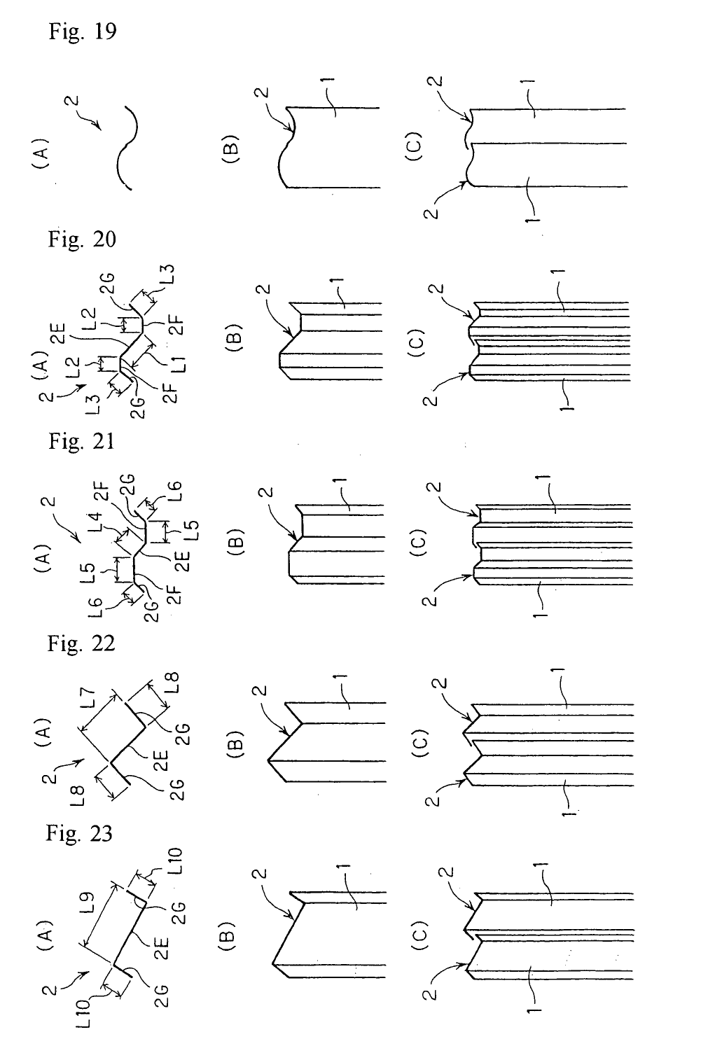

More particularly, the louver hook 2 is shaped into the inverted sigmoid shape in the cross section in each of the above-mentioned embodiments, as shown in FIG. 19(A). When the louver 1 is attached to the louver hook 2, the louver 1 is shaped into the inverted sigmoid shape by the louver hook 2 as shown in FIG. 19(B). As shown in FIG. 19(C), the end portions are overlapped in the inverted sigmoid shaped louvers which are adjacent to each other, in order to make the louvers 1 continue.

As shown in FIG. 20(A), louver hook 2 is composed of a central slant line portion 2E having a length of L1, rail direction straight line portions 2F and 2F, and outer slant line portions 2G and 2G. Each of the rail direction straight line portions 2F and 2F has a length of L2 and the rail direction straight line portions 2F and 2F are connected to both ends of the central slant line portion 2E, respectively. Each of the outer slant line portions 2G and 2G has a length of L3 and the outer slant line portions 2G and 2G are connected to the rail direction straight line portions 2F and 2F, respectively. The louver hook 2 is shaped into the inverted sigmoid shape of polygonal shape. When the louver 1 is attached to the inverted sigmoid shaped louver hook 2 of polygonal shape, the louver 1 is shaped into the inverted sigmoid shape of polygonal shape as shown in FIG. 20(B). It is possible to make the louvers 1 continue as shown in FIG. 20(C), when overlapping the end portions of the adjacent louvers 1 having the inverted sigmoid shape of polygonal shape. As a result, it is possible to form many polygonal folds in the louver 1. It is possible to prevent the louver 1 from twisting, inasmuch as the louver 1 has strength with respect to a longitudinal bending.

As shown in FIG. 21(A), louver hook 2 is composed of a central slant line portion 2E having a length of L4 which is less than the length L1 of FIG. 20(A), rail direction straight line portions 2F and 2F, and outer slant line portions 2G and 2G. Each of the rail direction straight line portions 2F and 2F has a length of L5 which is greater than the length L2 of FIG. 20(A) and the rail direction straight line portions 2F and 2F are connected to both ends of the central slant line portion 2E, respectively. Each of the outer slant line portions 2G and 2G has a length of L6 which is less than the length L3 of FIG. 20(A) and the outer slant line portions 2G and 2G are connected to the rail direction straight line portions 2F and 2F, respectively. The louver hook 2 is shaped into the inverted sigmoid shape of polygonal shape. When the louver 1 is attached to the louver hook 2, the louver 1 is shaped into the inverted sigmoid shape of polygonal shape as shown in FIG. 21(B). It is possible to make the louvers 1 continue as shown in FIG. 21(C), when overlapping the end portions of the adjacent louvers 1 having the inverted sigmoid shape of polygonal shape. As a result, it is possible to form many polygonal folds in the louver 1. It is possible to prevent the louver 1 from twisting, inasmuch as the louver 1 has strength with respect to a longitudinal bending.

As shown in FIG. 22(A), louver hook 2 is composed of a central slant line portion 2E having a length of L7 and outer slant line portions 2G and 2G. Each of the outer slant line portions 2G and 2G has a length of L8 and the outer slant line portions 2G and 2G are connected to the both ends of the central slant portion 2E, respectively. The louver hook 2 is shaped into a crank shape. When the louver 1 is attached to the crank shaped louver hook 2, the louver 1 is shaped into a crank shape as shown in FIG. 22(B). It is possible to make the louvers 1 continue as shown in FIG. 22(C), when overlapping the end portions of the adjacent crank shaped louvers 1. As a result, it is possible to simply bend the louver 1 and it is possible to form a large plane area on the louver 1 in case of closing the blind.

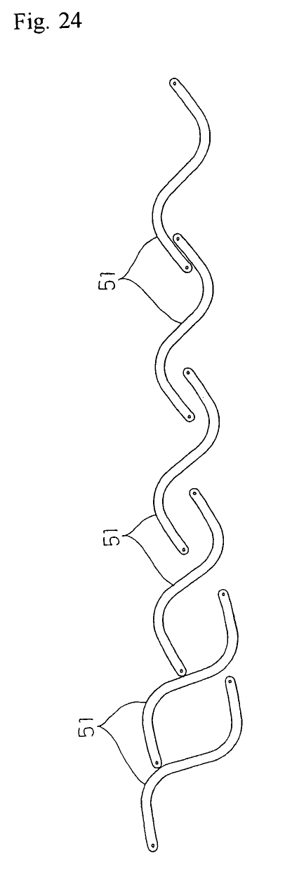

As shown in FIG. 23(A), louver hook 2 is composed of a central slant line portion 2E having a length of L7 which is greater than the length L7 of FIG. 22(A), and outer slant line portions 2G and 2G. Each of the outer slant line portions 2G and 2G has a length of L10 which is less than the length L8 of FIG. 22(A) and the outer slant line portions 2G and 2G are connected to the both ends of the central slant portion 2E, respectively. The louver hook 2 is shaped into a crank shape. When the louver 1 is attached to the crank shaped louver hook 2, the louver 1 is shaped into a crank shape as shown in FIG. 23(B). It is possible to make the louvers 1 continue as shown in FIG. 23(C), when overlapping the end portions of the adjacent crank shaped louvers 1. As a result, it is possible to simply bend the louver 1 and it is possible to form a larger plane area on the louver 1 in case of closing the blind.

As described above, it is possible to form a shape with fold in which at least one of the side edges in the width direction is directed to the different direction with respect to the intermediate portion thereof in the horizontal section in the flexible cloth louver or the soft plastic louver according to the blind of the present invention, even though the louver is not manufactured as a hard louver which has the shape in which at least one of the side edges in the width direction is always directed to the different direction with respect to the intermediate portion thereof in the entire length. As a result, it is possible to cheaply manufacture the blind in which the louver has a fold. It is possible to deal with the louver of the present invention in a manner similar to a conventional usual strip shaped cloth louver or a conventional soft plastic louver in use, management, or transport fashion.

1. A blind comprising a louver which is suspended by a louver hook to a carrier of a runner group which runs along a rail, wherein:
said louver is made of a flexible material;
said louver hook having a shape in which at least one of end portions in a width direction is directed to a different direction with respect to an intermediate portion thereof in a plane view;
said flexible louver being stabilized into a shape with a fold in which at least one of side edges in the width direction is directed to a different direction with respect to an intermediate portion thereof in a horizontal section, by said louver hook.

2. A blind comprising a louver which is suspended by a louver hook to a carrier of a runner group which runs along a rail, wherein:
said louver hook comprises:
a hook main body whose at least one of end portions in a width direction is directed to a different direction with respect to an intermediate portion thereof in a plane view; and
a louver clip having a shape similar to said hook main body, said louver clip being retractably attached to one end portion of said hook main body;
an upper end portion of said louver made of the flexible material being sandwiched between said hook main body and said louver clip so that said louver has a shape with a fold in which at least one of side edges in the width direction is directed to a different direction with respect to an intermediate portion thereof in a horizontal section.

3. A blind as claimed in claim 2, wherein:
both end portions in the width direction of said hook main body are bent so as to warp said both end portions to reverse directions with respect to half portions thereof in the width direction; and
both end portions in the width direction of said louver clip are bent so as to warp said both end portions to reverse directions with respect to half portions thereof.

4. A blind comprising a louver which is suspended by a louver hook to a carrier of a runner group which runs along a rail, wherein:
said louver hook comprises:
a hook main body whose at least one of end portions in a width direction is directed to a different direction with respect to an intermediate portion thereof in a plane view; and
a louver clip having a shape similar to said hook main body, said louver clip being retractably attached to one end portion of said hook main body;
an upper end portion of said louver made of the flexible material being sandwiched between said hook main body and said louver clip so that said louver has a shape with a fold in which at least one of side edges in the width direction is directed to a different direction with respect to an intermediate portion thereof in a horizontal section; and
said hook main body having a hook guide body and a guide roller which is positioned at an end portion of the hook main body.

5. A blind comprising a louver which is suspended by a louver hook to a carrier of a runner group which runs along a rail, wherein:
said louver hook comprises:
a hook main body whose at least one of end portions in a width direction is directed to a different direction with respect to an intermediate portion thereof in a plane view; and
a louver clip having a shape similar to said hook main body, said louver clip being retractably attached to one end portion of said hook main body;
an upper end portion of said louver made of the flexible material being sandwiched between said hook main body and said louver clip so that said louver has a shape with a fold in which at least one of side edges in the width direction is directed to a different direction with respect to an intermediate portion thereof in a horizontal section; and
said hook main body having a rotatable hooking portion which is hooked to said carrier.
